(19) United States
(12) Patent Application Publication
(10) Pub. No.: US 2017/0217649 A1
(43) Pub. Date: Aug. 3, 2017

(54) DISPENSER WITH VALVED NOZZLE CLOSURE

(71) Applicant: Rieke Packaging Systems Limited, Leicester (GB)

(72) Inventor: SIMON CHRISTOPHER KNIGHT, Bridgend (GB)

(21) Appl. No.: 15/489,898

(22) Filed: Apr. 18, 2017

Related U.S. Application Data
(63) Continuation of application No. PCT/GB2015/053127, filed on Oct. 20, 2015.
(60) Provisional application No. 62/066,011, filed on Oct. 20, 2014.

(51) Int. Cl. B65D 47/20; B05B 11/04; B65D 47/08

(52) U.S. Cl. CPC B65D 47/2081; B65D 47/0842; B05B 11/047

(57) ABSTRACT

A dispenser for a fluid product comprising a container constructed and arranged for holding a supply of fluid product and a closure subassembly received by the container and providing an outlet opening for dispensing at least a portion of the supply of fluid product. The closure subassembly includes a valve with a first valve component and assembled therewith a second valve component.

### CROSS REFERENCE TO RELATED APPLICATIONS

This application is a continuation of PCT/GB2015/053127 filed Oct. 20, 2015, which claims the benefit of U.S. Provisional Application No. 62/066,011 filed Oct. 20, 2014, which are hereby incorporated by reference.

### BACKGROUND

In the product dispensing art, various outlet constructions may be utilized as part of the dispensing mechanism or as part of the product container. When a dispensing mechanism is used, such as piston pump, the outlet may be as simple as a nozzle with an outlet opening at a distal end. Depending on the type of product being dispensed, the viscosity of that product and any related characteristics or properties, there may be some value to the end user in having other design concepts integrated into the construction of the outlet, whether a nozzle outlet or an outlet of some other form.

As one example, when a product is being dispensed which has a foam consistency, it might be seen as a benefit if any residual foam which may be in the outlet can be sucked back into the pump or at least back into some area where drying out of that residual foam is not likely to be an issue. First, sucking back the residual foam reduces the risk of it dripping onto a surface, such as a countertop. Secondly, sucking back the residual foam may prevent that portion of foam from drying out in the outlet causing a clog if use of the dispensing pump (i.e. dispenser) happens to be infrequent.

Another means of dispensing a fluid product, though not by the use of an actual dispensing mechanism, such as a piston pump, is the use of a flexible squeeze container. As one example, consider a flexible plastic condiment dispenser and the product contained therein such as mustard or catsup. This product is able to be dispensed by squeezing the flexible sides of the plastic container. The “dispenser” in this example includes the container which holds the product and some type of closure, cap, cover or lid. For this disclosure, the term “closure” is used to generically denote the component which is attached to the squeeze container for closing off the squeeze container neck opening. It is the closure which defines the dispensing opening or dispensing outlet for the product which is within the container. Whether the container is inverted or upright at the time of dispensing, as the container sides are squeezed together the interior space or volume of the container is reduced to some extent and as a result, the pressure increases and the product moves to find space. Depending on the size of the container, the volume of product remaining in the container and the degree or extent of squeezing the container, it is possible to force product out of the container and through the dispensing outlet of the closure. This can all be done while the user manipulates the dispenser so as to direct the product being dispensed to the desired location.

Just as with the pump dispenser example, depending on the type of product being dispensed from the squeeze container, including the viscosity of the product and its related characteristics and properties, there may be value to the end user in having other design concepts integrated into the construction of the closure. As one example, incorporating an anti-drip feature into the closure may be considered as a beneficial feature of the dispenser. One construction currently employed as part of a closure for a squeeze container is a slit valve. This is a flexible, elastomeric component wherein the dispensing opening is normally closed. When an internal pressure (i.e. fluid force) is generated, such as by squeezing the sides of the flexible container, the sides of the elastomeric slit valve deflect in response to the pressure force and the slit valve opens thereby allowing product to flow through the opening which is created and is defined by the spaced-apart edges of the slit. When the internal pressure or fluid force is relaxed or removed, the elastomer properties of the slit valve react to close the opening. The slit valve can also open in the opposite direction to let in make-up air.

Over time these types of elastomeric slit valves can exhibit “issues” for the end user (e.g. the customer). Product may be caught and retained in and around the slit valve and then later dry out. The elastomeric properties of the slit valve may degrade over time with repeated use. The slit closing may not be as complete, perhaps causing the product to drip or perhaps resulting in contamination of the remaining product in the container.

In view of these potential “issues”, it was felt that a different style of closure was needed and that different style of closure is disclosed herein in the form of a novel and unobvious valve structure incorporated into a closure for a container. In the disclosed form of the exemplary embodiment, the closure includes a valved nozzle for the control of product dispensing.

### SUMMARY

A product dispenser includes a squeeze container and a cooperating closure which has a valved nozzle for the control of product dispensing. While a squeeze container is used for the exemplary embodiment, the principles of the valved nozzle are fully applicable whenever an interior pressure or fluid force is able to be created. It is this interior pressure or fluid force which causes the movement of one valve nozzle component relative to another valve nozzle component in order to open a flow path for the dispensing of product. The pressure or fluid force could be created by a piston pump mechanism in lieu of a squeeze container which is the selected construction for the exemplary embodiment. In the exemplary embodiment it is the force of the fluid product flowing against a surface of the one valved nozzle component which results in the opening of the fluid flow path for the dispensing of product.

The use of a squeeze container as the exemplary embodiment enables a focus on the closure construction without needing to focus on the manner of creating the valve-opening fluid force. As disclosed herein, the container is the component part responsible for the delivery of the requisite valve opening force (fluid pressure). The closure is attached to or received by the container by any suitable mechanism, such as by a snap-fit connection or by thread engagement, and the closure includes the valved nozzle which is constructed and arranged with two valve components. These two valve components are normally closed and the movement of one relative to the other opens a product flow path through the nozzle. The fluid flow path through the nozzle for dispensing of product is between the two valve components.

For the exemplary embodiment, lower cost plastics can be used, the component count is lower as compared to various prior art constructions and the disclosed dispenser is suitable for a variety of fluid products, including beverages and condiments. The closure construction of the exemplary embodiment permits the intake of make-up air back into the container when the squeezing force on the container is relaxed or removed and the container returns to or close to its initial condition.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a dispenser according to an exemplary embodiment of the present invention with a flip cap in an open condition.

FIG. 2 is a perspective view of the FIG. 1 dispenser.

FIG. 3 is a left side elevational view of the FIG. 1 dispenser.

FIG. 4 is a front elevational view of the FIG. 1 dispenser.

FIG. 5 is a top plan view of the FIG. 1 dispenser.

FIG. 6 is a left side perspective view of a closure which comprises one component part of the FIG. 1 dispenser.

FIG. 7 is a top perspective view of the FIG. 6 closure.

FIG. 8 is a bottom perspective view of the FIG. 6 closure.

FIG. 9 is a bottom perspective view of the FIG. 6 closure.

FIG. 10 is an exploded view of the FIG. 6 closure with its cooperating valve disk illustrated separately.

FIG. 11 is a top plan view of the FIG. 6 closure.

FIG. 12 is a left side elevational view of the FIG. 6 closure.

FIG. 13 is a front elevational view of the FIG. 6 closure.

FIG. 14 is a rear elevational view, in full section, of the FIG. 1 dispenser.

FIG. 15 is an enlarged rear elevational view of the closure and valve disk subassembly associated with the FIG. 14 dispenser.

FIG. 16 is a right side elevational view, in full section, of the FIG. 1 dispenser.

FIG. 17 is an enlarged, right side elevational view of the closure and valve disk subassembly associated with the FIG. 16 dispenser.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

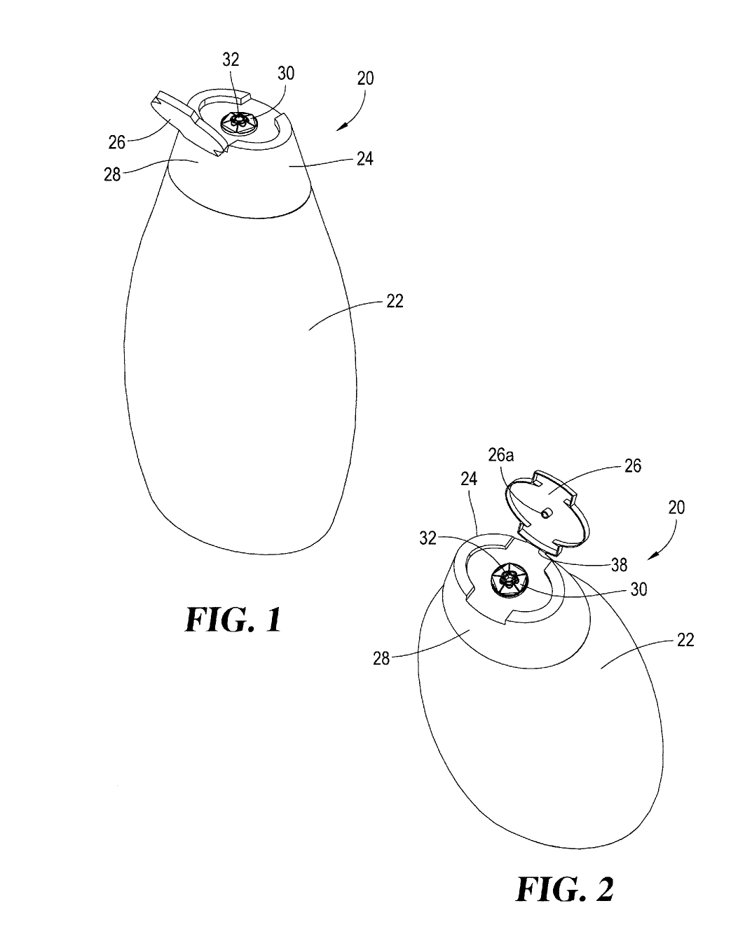

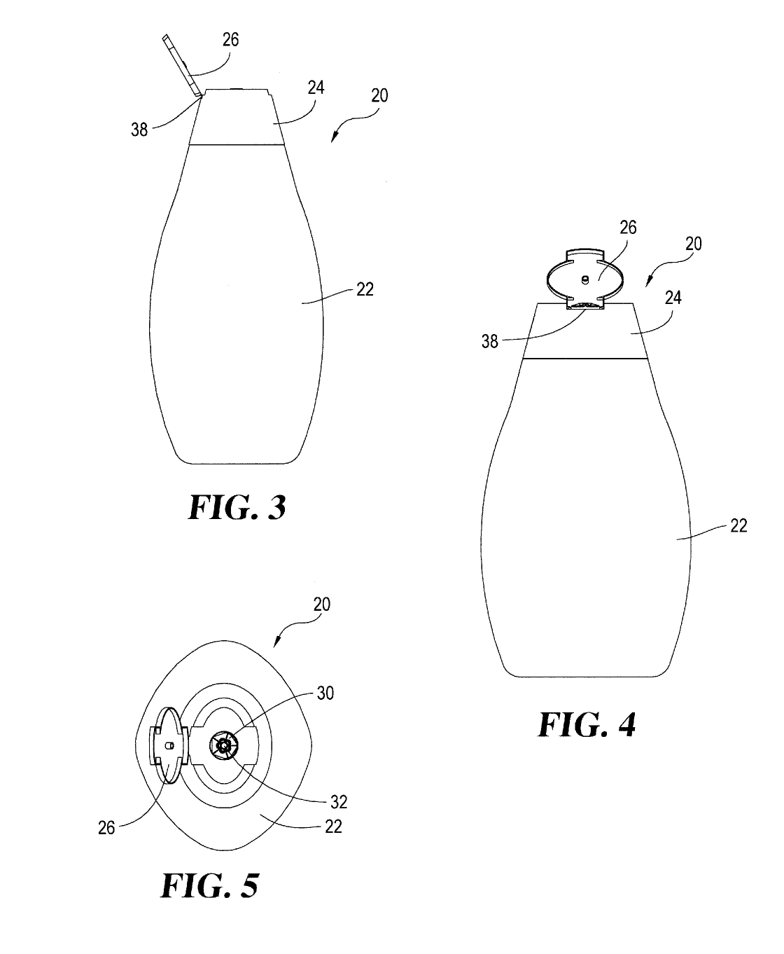

Referring to FIGS. 1-5, there is illustrated a dispenser 20 according to an exemplary embodiment of the present invention. Dispenser 20 includes a container 22 and a closure 24 which is attached to the container 22. The closure 24 includes a hinged flip cap 26 and a closure body which defines nozzle 30. The nozzle 30 defines an outlet 32 for dispensing product which is held in container 22. The subassembly which is attached to dispenser 20 includes not only closure 24 but a valve disk 34 which is assembled into closure 24, as described in greater detail herein. Further, a small projection 26a is formed as an integral part of flip cap 26 and is inserted into and used to close off outlet 32 when dispenser 20 is not in use. In describing that the closure 24 is attached to the container 22, the specific style or manner of attachment may vary depending on the size and material of these component parts and depending on the type of product to be dispensed.

In the exemplary embodiment the closure 24 may be fabricated from a polymer such as polypropylene. The valve disk 34 may also be fabricated out of polypropylene. Accordingly, these two components may be fabricated out of the same polymer whether or not polypropylene is selected.

In the exemplary embodiment of FIG. 1, closure 24 is constructed and arranged with a cooperating snap-fit feature with a similar and cooperating structure for the container 22 so that these two components can be snapped together for the completion of dispenser 20, noting that closure 24 would include the referenced valve disk 34 as part of the closure subassembly. While other connection structures, features and techniques are contemplated, such as having a threaded connection between the closure and the container, the key is that there is a secure connection between the closure 24 and the container 22, regardless of the specific construction technique which is selected. With a secure connection between the closure 24 and container 22, the interior pressure due to squeezing of the flexible container will not cause the closure 24 to come off or disengage from the container 22.

Assembled into closure 24, as explained, is a valve disk 34 (see FIG. 8). Valve disk 34 is a relatively thin, generally circular member with an annular array of clearance openings 36 which function as flow apertures for product. These flow apertures allow the product coming from within the container to pass through valve disk 34 and engage a portion of the nozzle 30 which ultimately causes that nozzle to flex and thereby creates a clearance path for that same portion of product to flow through outlet 32 and thereby be dispensed. In the exemplary embodiment the valve disk 34 is a molded plastic (single piece) component with six equally spaced openings 36. As shown in FIG. 10, valve disk 34 includes a raised, outer annular lip 34a on one face of the valve disk. The closure 24 is a single-piece, molded plastic component which is formed (i.e. molded) with the nozzle 30 and the flip cap 26 as well as a living hinge 38 which joins the flip cap 26 to the closure body 28.

The container 22 is a single-piece, molded plastic component with flexible sides suitable in size and shape for grasping and squeezing. As the sides of the container 22 are manually squeezed they deflect inwardly which causes the container 22 volume to be reduced and this in turn forces product which is stored in the container to flow upwardly (path of least resistance) into the closure and ultimately out through nozzle outlet 32. The oval shape of container 22 (in lateral section) contributes to the ease of grasping and squeezing by the user. When the grasping force of the user's hand is removed from the side walls of the container, the container returns to its starting shape or at least close to its starting shape due to its plastic construction and the inherent material properties of plastics. This return or restoration of the container shape is expected based on its construction, and selection of materials. As the container 22 returns to its starting shape, a suction force is created and this suction force draws in make-up air through nozzle 30, into the interior of the container. Assuming that the container substantially returns to its initial or starting size, shape and volume this make-up air replaces the volume of product which was dispensed.

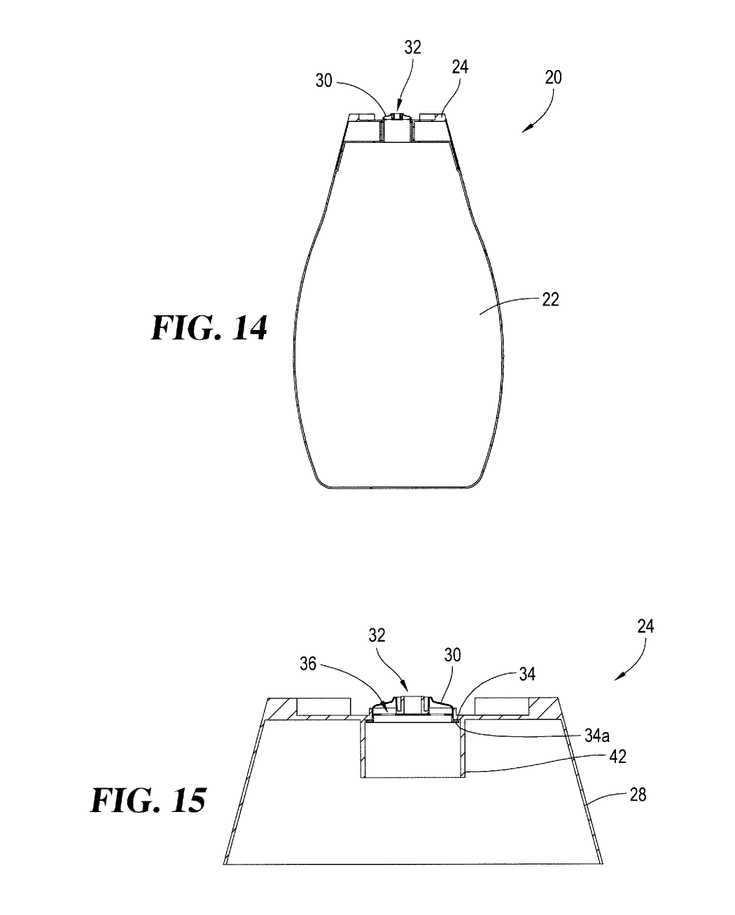

The upper panel 40 of closure body 28 includes a depending sleeve 42 which is generally concentric with the outer periphery of nozzle 30. This sleeve 42 extends axially inwardly toward the interior of the container 22 and provides a generally cylindrical space for the receipt of valve disk 34. One option for the assembly of valve disk 34 into sleeve 42 is by means of suitable bumps, projections, ribs and/or detents such that the valve disk 34 snaps into sleeve 42 in a securely retained fashion, axially positioned beneath nozzle 30, see FIGS. 14-17. Another option, considering the plastic construction of valve disk 34 and the plastic construction of sleeve 42, is to use an interference fit and simply press fit the valve disk 34 into position.

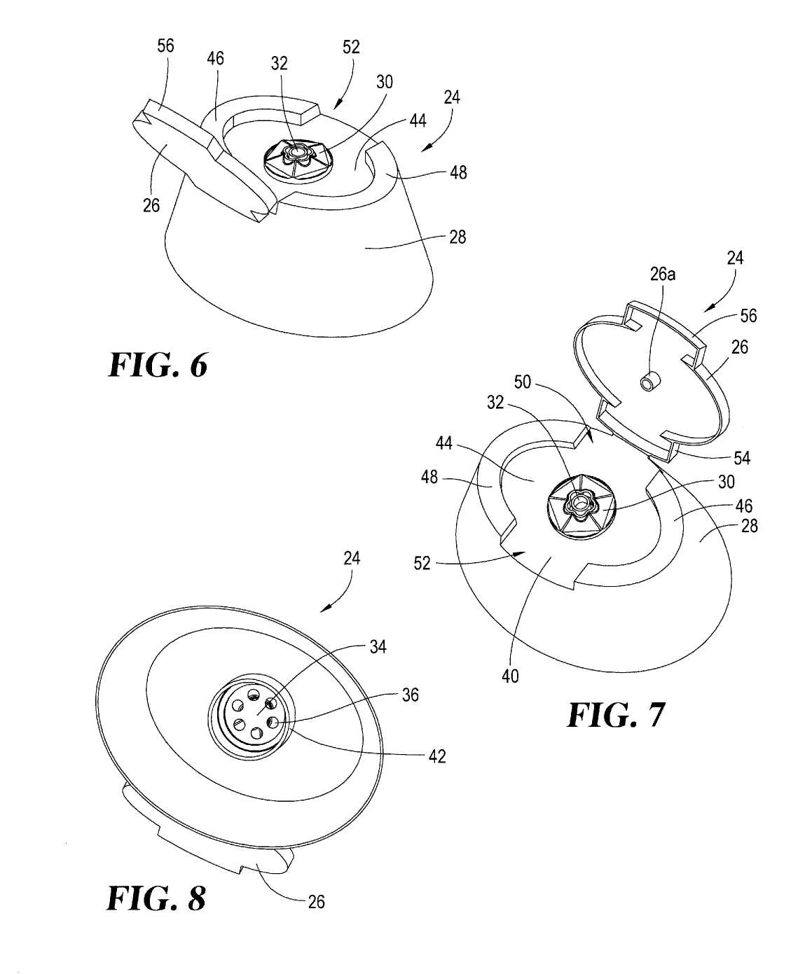

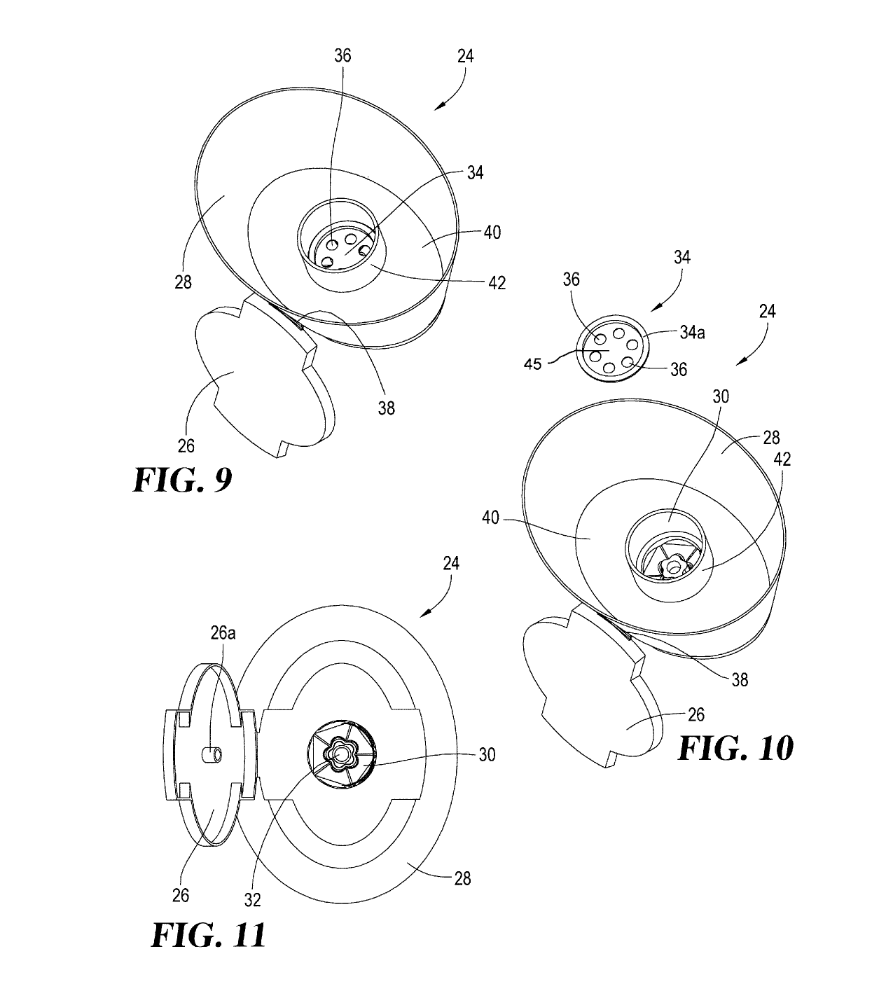

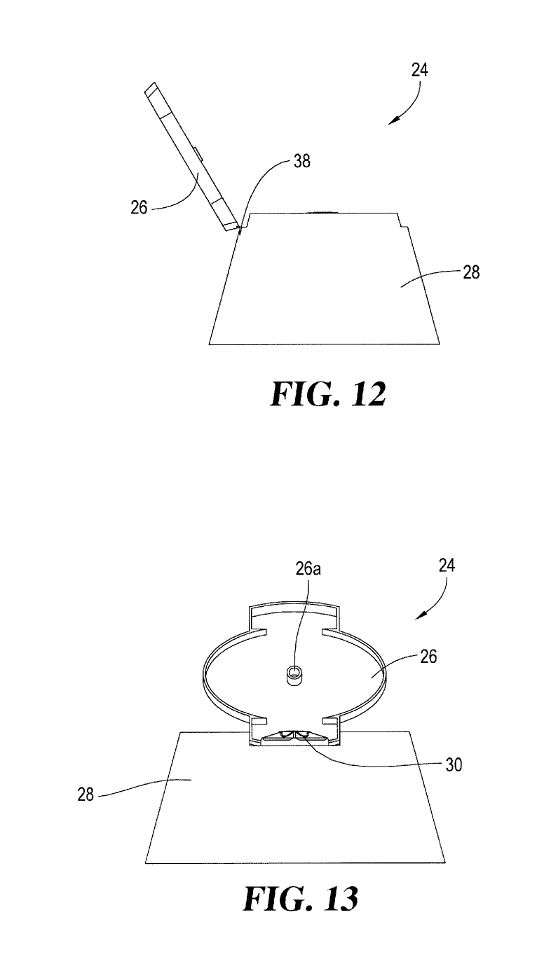

Referring to FIGS. 6-13, the structural details of the closure 24, the flip cap 26, the nozzle 30, the valve disk 34 and the sleeve 42 are illustrated. Features of these structural components are described above. The upper panel 40 includes a recessed center area 44 which is surrounded, in part, by two raised arc-like sections 46 and 48. Clearance notches 50 and 52 are created by this construction and the projecting portions 54 and 56 of flip cap 26 fit into notches 50 and 52, respectively, in order to provide a flush appearance for the top of closure 24 when the flip cap 26 is closed.

In operation, after first opening the flip cap 26, a user manually compresses or squeezes together the sides of the container in an inward direction which causes a portion of the product remaining in the container to be dispensed. The amount, degree or level of squeeze force depends in part on the size of the container and in part on the amount of product remaining in the container. Whatever these variables might be, the user can gauge what is needed by monitoring the flow of product through outlet 32.

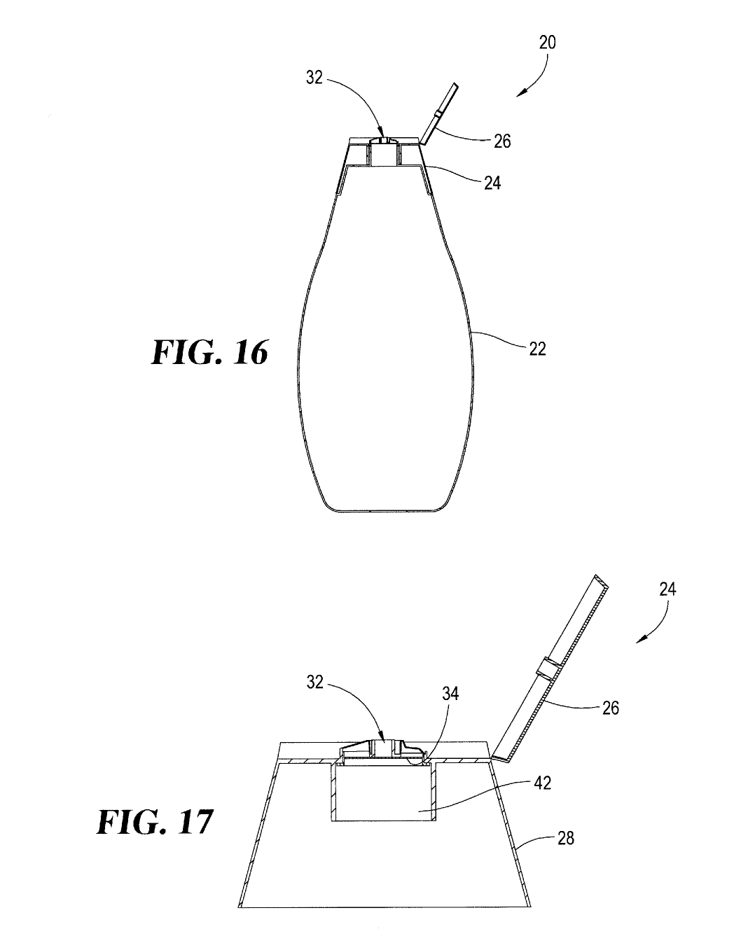

The combination of closure 24 and valve disk 34 creates a novel and unobvious valve structure (closure subassembly) for the management of product dispensing from container 22. Focusing now on the section views of FIGS. 14-17, the details of this two-piece valve structure are illustrated. The entire dispenser is shown in full section form in FIGS. 14 and 16 with different geometric cutting planes for each of those two views. The enlarged detail drawings of FIGS. 15 and 17 correspond to FIGS. 14 and 16, respectively, and focus on the valve structure following the same two geometric cutting planes. The closure subassembly represented by FIG. 15 corresponds to the structure employed in the dispenser of FIG. 14 and similarly FIG. 17 corresponds to FIG. 16.

Looking at further at FIGS. 15 and 17, it will be seen that sleeve 42 extends down from upper panel 40 and is an integrally molded portion of closure 24. The nozzle 30 defines outlet 32 and valve disk 34 which has a solid enclosed center portion 44 is positioned (snap-in or press-in fit), up against the interior face of outlet 32 thereby closing off outlet 32. In the exemplary embodiment, nozzle 30 is an integrally molded part of closure 24. This means that the closing structure for container 22 includes two components which are assembled into the closure subassembly. These two component parts include the closure 24 and the valve disk 34.

When the container is squeezed with sufficient force to dispense product, the portion of product to be dispensed flows upwardly through openings 36. The product then contacts an inner surface of nozzle 30 which surrounds outlet 32. The force of the product flow which is directed against the inner surface of nozzle 30 causes a slight deflection of the nozzle and as a result, the nozzle bows upwardly with a slight convex contour on the outer facing surface of the nozzle. As the inner facing surface of the nozzle becomes slightly concave, a corresponding result of this described bowing, the clearance space is created between the interior face of outlet 32 and the valve disk 34 thereby allowing product to flow through this clearance space and to be dispensed. As the container returns to its initial shape, a suction force (negative pressure) replaces the positive pressure within the container. This suction force pulls the valve disk 34 away from the outlet 32 so that make-up air can enter the container by way of outlet 32. This then restores the dispenser 20 back to a ready condition for its next dispensing cycle. The flow of make-up air can assist in blowing back into the container residual product which may have been left on or around the two valve components.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A dispenser for a fluid product comprising:
a container constructed and arranged for holding a supply of fluid product; and
a closure subassembly received by said container and providing an outlet opening for dispensing at least a portion of said supply of fluid product, said closure subassembly including a valve with a first valve component and assembled therewith a second valve component.

2. The dispenser of claim 1 wherein said valve is openable by said portion of said supply of fluid product.

3. The dispenser of claim 1wherein said closure subassembly includes a closure and said closure includes said first valve component.

4. The dispenser of claim 1wherein said second valve component is a valve disk.

5. The dispenser of claim 4 wherein said valve disk defines a product flow opening.

6. The dispenser of claim 1 wherein said closure defines an outlet for directing said portion of said supply of fluid product to said outlet opening.

7. The dispenser of claim 6 wherein said outlet is a part of said first valve component.

8. The dispenser of claim 7 wherein said second valve component is constructed and arranged to close off one end of said outlet.

9. The dispenser of claim 1wherein said container is a squeeze container which is free of any separate pump mechanism.

10. The dispenser of claim 1wherein said closure subassembly is a single-piece, plastic component.

11. The dispenser of claim 1wherein said first valve component is constructed and arranged to flex in response to fluid pressure supplied by said portion of said supply of fluid product.

12. The dispenser of claim 11 wherein when said first valve component flexes a flow path for said portion of said supply of fluid product is created.

13. The dispenser of claim 12 wherein said created flow path is between said first valve component and said second valve component.

14. The dispenser of claim 1wherein said closure subassembly includes a flip cap for closing off said outlet opening.

15. The dispenser of claim 14 wherein said flip cap is hinged to the remainder of said closure as part of a single-piece construction for said closure.

16. A dispenser for a fluid product comprising:
a container constructed and arranged for holding a supply of fluid product;
a closure received by said container; and
a valve member which is assembled into said closure.

17. The dispenser of claim 16 wherein said closure is a single-piece component which defines a flow nozzle with an outlet through said flow nozzle.

18. The dispenser of claim 16 wherein said closure includes a cooperating valve component for engagement with said valve member to create an outlet control valve.

19. The dispenser of claim 18 wherein said cooperating valve component is constructed and arranged to flex in response to fluid pressure supplied by a portion of said supply of fluid product.

20. The dispenser of claim 19 wherein said valve member is constructed and arranged as a disk which defines a plurality of flow openings.
